(19) United States
(12) Patent Application Publication
(10) Pub. No.: US 2018/0240058 A1
(43) Pub. Date: Aug. 23, 2018

(54) METHOD AND ELECTRONIC SYSTEM FOR GENERATING JOB BOOKINGS

(71) Applicant: Codafication Pty Ltd, Fortitude Valley (AU)

(72) Inventors: Christian Vandersee, Fortitude Valley (AU); Geoffrey King, Fortitude Valley (AU); Daniel Sandaver, Fortitude Valley (AU)

(73) Assignee: Codafication Pty Ltd, Fortitude Valley (AU)

(21) Appl. No.: 15/754,632

(22) PCT Filed: Aug. 24, 2016
(86) PCT No.: PCT/AU2016/050781

§ 371 Date: Feb. 23, 2018

(30) Foreign Application Priority Data
Aug. 24, 2015 (AU) 2015903412

(51) Int. Cl. G06Q 10/06

(52) U.S. Cl. CPC G06Q 10/06313; G06Q 10/06315

(57) ABSTRACT

A method and system for generating job bookings may quickly and accurately create job bookings for project tasks with minimal labor or input required from a project manager. Furthermore, the method and system may allow a resource supplier to be quickly and efficiently selected based on their previous performance, such as cost, in relation to other resource suppliers and their efficiency in completing a job within given time constraints, as well as relevant contextual factors such as their location and qualifications. Customer satisfaction feedback regarding a project manager, instructor and/or resource supplier then can be provided in real time to various parties to ensure that a level of customer satisfaction does not drop below a predetermined minimum.

### CROSS-REFERENCE TO RELATED APPLICATIONS

This application is U.S. national stage application under 35 U.S.C. § 371 of PCT Application Number PCT/AU2016/050781 filed Aug. 24, 2016, which claims the benefit of Australian Patent Application Number 2015903412 filed Aug. 24, 2015. The subject matter of these earlier filed applications is hereby incorporated by reference in its entirety.

### FIELD

This invention relates generally to a method of generating job bookings in an electronic system, and in particular to a method of generating job bookings in an electronic system for, but not limited to, building services.

### BACKGROUND

Providing effective scheduling and resourcing of projects is important across a wide range of industries, including for example construction, mining and manufacturing, to name just a few. Resourcing of projects is typically performed manually by a project manager or coordinator through a slow iterative process. The manager generally first must identify the availability of the multiple resources that will be required to deliver the project, and then must manually assign the resources to perform the requisite tasks within defined time windows, including verifying all dates against other project constraints (e.g., customer availability, deadlines, etc.). The need to carefully and thoroughly perform these planning activities typically results in a delayed start time for a project.

There are typically multiple processes and tasks, and multiple resources, such as tradesmen, available to complete a given job. However, there is often little information available to assist in effectively determining a particular worker's ability to complete a task to a satisfactory standard and whether the worker can complete a task in a quoted timeframe. Furthermore, similar tasks that need to be completed across multiple projects are often poorly documented, making it difficult to utilize templates from previous projects to reduce planning and scheduling time.

Also, the time required for effective project scheduling generally increases with the size of a project due to many factors, and the scheduling of individual job tasks with available resources is a significant and time consuming challenge.

Various electronic project scheduling tools, including spreadsheets and Gantt charts, are available; however, such tools generally do not enable effective use of prior scheduling templates and up to date data on supplier work parameters and supplier time constraints. Further, such prior art tools generally do not enable the automated generation and monitoring of job bookings using real time feedback from customers and other stake holders.

There is therefore a need for an improved method of generating job bookings in an electronic system.

The reference to any prior art in this specification is not, and should not be taken as, an acknowledgement or any form of suggestion that the prior art forms part of the common general knowledge in Australia or elsewhere.

### SUMMARY

Certain embodiments of the present invention may provide solutions to the problems and needs in the art that have not yet been fully identified, appreciated, or solved by conventional job booking generation systems. For example, some embodiments pertain to a method and system that can quickly and accurately create job bookings for project tasks with minimal labor or input required from a project manager. Furthermore, the method and system may allow a resource supplier to be quickly and efficiently selected based on their previous performance, such as cost, in relation to other resource suppliers and their efficiency in completing a job within given time constraints, as well as relevant contextual factors such as their location and qualifications. Customer satisfaction feedback regarding a project manager, instructor and/or resource supplier then can be provided in real time to various parties to ensure that a level of customer satisfaction does not drop below a predetermined minimum.

In one form, although not necessarily the only or the broadest form, the present invention resides in a method of generating job bookings in an electronic system that includes receiving a project request in the electronic system and assigning a project template to the project request. The project template identifies task work parameters and task time constraints for each of a plurality of tasks required to complete a project. The method also includes retrieving, by the electronic system, supplier work parameters and supplier time constraints concerning first resource suppliers related to the plurality of tasks and automatically generating, by the electronic system, first task-supplier matches by matching the supplier work parameters and supplier time constraints with the task work parameters and task time constraints related to the plurality of tasks. The method further includes automatically generating, by the electronic system, a comparison of the first task-supplier matches with alternative task-supplier matches concerning alternative resource suppliers and generating, by the electronic system a plurality of project schedule options using the first task-supplier matches and the alternative task-supplier matches. Additionally, the method includes generating job bookings, by the electronic system, based on a project schedule selected from the plurality of project schedule options.

The project template may include an electronic file that defines task work parameters and task time constraints of an earlier project.

The first resource suppliers may include a contractor, tradesman, inspector, machine, or vehicle.

The task work parameters and task time constraints identified in the project template may be modified to suit current parameters of the project request.

The task time constraints may include a start and end date relevant to a task.

The task work parameters may include one or more of a task description and a location of the task.

The supplier work parameters may include at least one of the first resource suppliers' qualifications, experience, location or feedback from previous customers of the at least one of the first resource suppliers.

The supplier time constraints may include one or more times that at least one of the first resource suppliers is available and one or more times that the at least one of the first resource suppliers is not available, as defined in an electronic calendar associated with the at least one of the first resource suppliers.

The supplier work parameters and supplier time constraints may be matched with the task work parameters and task time constraints based on at least one of the qualifications, experience, location, availability or feedback from previous customers of at least one of the first resource suppliers.

The project request may be received via a business-to-business platform.

The supplier work parameters may be retrieved from a mobile application.

The supplier work parameters may be retrieved and updated in the electronic system in real-time.

The project schedule options may be transmitted to an electronic device via one of an email, web application or mobile application.

The first resource suppliers may update the supplier work parameters and the supplier time constraints via a mobile application or a web-based application.

The supplier work parameters may include a first resource supplier score that is updated in real time based on feedback from previous customers of the first resource suppliers.

The plurality of project schedule options may be transmitted to a customer via an email, mobile or web-based application. One option from the plurality of project schedule options that is selected by the customer may then be transmitted to the electronic system.

The job bookings may be transmitted to an email, mobile or web-based application of an electronic device of a customer.

The method may further include displaying a customer service index (CSI) on an interface of the electronic system.

A CSI may be generated for each resource supplier and instructor of a project.

The CSI may be based on data received in real time from a plurality of electronic devices associated with a customer and at least one resource supplier.

An alert may be generated when the CSI drops below a predetermined level.

In another form, the present invention resides in an electronic system for executing the method described above.

In yet another form, the present invention resides in a computer readable medium including computer program instructions which, when executed on an electronic system, executes the method described above.

It is an object of some embodiments of the present invention to provide the industry with improvements and advantages over the above described prior art, and/or overcome and alleviate one or more of the above described disadvantages of the prior art, and/or provide a useful commercial choice.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 is a diagram of a network for generating job bookings in an electronic system, according to some embodiments of the present invention;

FIG. 2 is a flow diagram of a method for generating job bookings in an electronic system, according to an embodiment of the present invention;

FIG. 3 is a flow diagram of a method for assigning the project template, in accordance with the method shown in FIG. 2;

FIG. 4 illustrates a graphical user interface for using the project templates in accordance with the method shown in FIG. 2;

FIG. 5 illustrates a graphical user interface for a first resource supplier to input supplier time constraints in accordance with the method shown in FIG. 2;

FIG. 6 illustrates a graphical user interface for entering and receiving feedback on a first resource supplier in accordance with the method shown in FIG. 2;

FIG. 7 illustrates a user interface in the form of an output including a plurality of project schedule options generated in accordance with the method shown in FIG. 2;

FIG. 8 is a block diagram of a specific embodiment of the electronic system of the present invention;

FIG. 9 is a block diagram illustrating the operation of a customer service index (CSI) inside of the network of FIG. 1, according to an embodiment of the present invention; and

FIG. 10 illustrates an example of a CSI visualisation interface, according to some embodiments of the present invention.

### DETAILED DESCRIPTION

Elements of some embodiments of the present invention are illustrated in concise outline form in the drawings, showing only those specific details that are necessary to understanding the embodiments of the present invention, but so as not to clutter the disclosure with excessive detail that will be obvious to those of ordinary skill in the art in light of the present description.

In this patent specification, adjectives such as first and second, left and right, front and back, top and bottom, etc., are used solely to define one element from another element without necessarily requiring a specific relative position or sequence that is described by the adjectives. Words such as “comprises” or “includes” are not used to define an exclusive set of elements or method steps. Rather, such words merely define a minimum set of elements or method steps included in a particular embodiment of the present invention. It will be appreciated that the present invention may be implemented in a variety of ways, and that this description is given by way of example only. In addition the method steps may be performed in a different order to those presented.

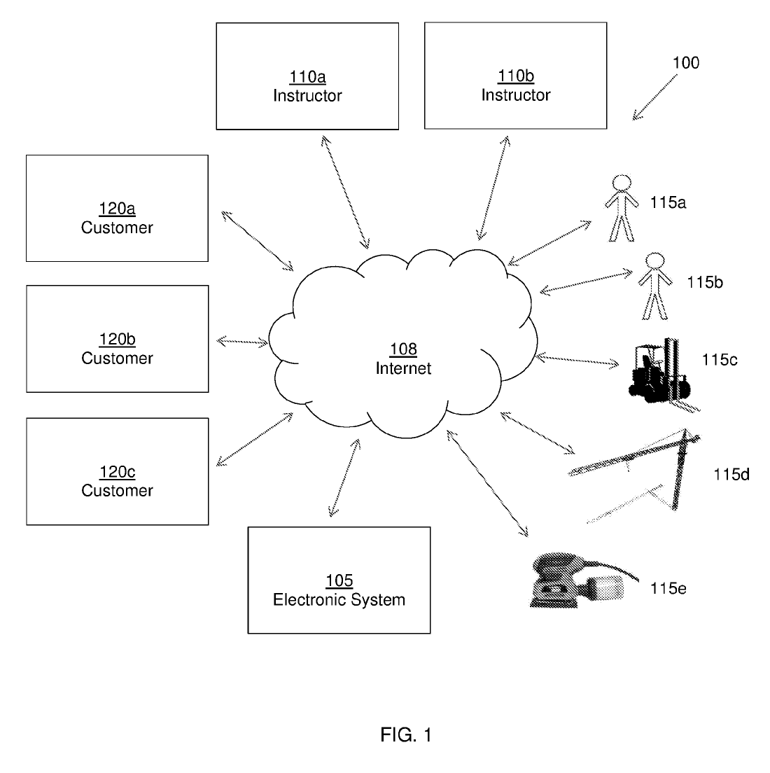

FIG. 1 is a diagram of a network 100 for generating job bookings in an electronic system 105, according to some embodiments of the present invention. For example, the electronic system 105 can reside on a server or computer of a business that is connected to the Internet 108. The system 105 receives data in real time from various sources such as instructors 110, resource suppliers 115, and customers 120 to rapidly and efficiently generate job bookings for a particular project.

To better illustrate features of the present technology, consider a situation where a major storm has damaged dozens of homes in a particular city. The system 105 can be deployed by a construction company to efficiently receive work orders and then quickly schedule and complete necessary repair work. For example, an instructor 110a can be an insurance company that sends a project request to the construction company via a business to business (b2b) platform. The project request can be made up of one or more tasks relevant to a project, such as repairing a home roof and related water damage inside a home. The construction company can then utilize the system 105 to quickly and efficiently schedule and coordinate each of several resource suppliers 115 for first preparing a cost and timing estimate for the work and then for completing the work. The resource suppliers 115a, 115b, for example, can include people such as plumbers, electricians, carpenters, painters, machinery operators and other tradesmen. The resource suppliers 115c, 115d, 115e can also include machinery such as forklifts, cranes, sanders, etc.

By receiving updates in real time concerning supplier work parameters and supplier time constraints based on electronic devices, such as smart phones associated with human resource suppliers 115, timing and cost requirements of specific work can be estimated and completed much more quickly and accurately.

Also, receiving feedback based on “Internet of things” networking between the system 105 and specific machines ensures that non-human resource suppliers 115 in the form of physical assets can be confidently deployed according to a schedule and in a functioning and well maintained condition.

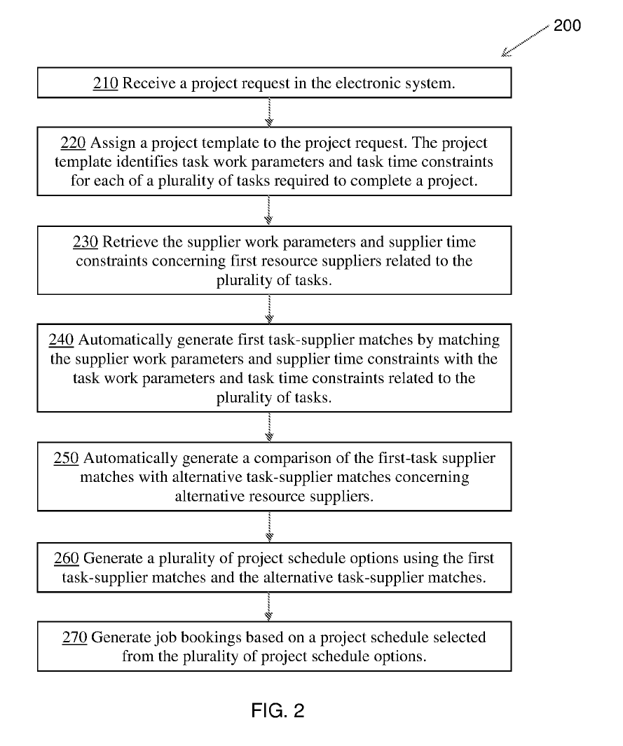

FIG. 2 is a block diagram of a method 200 of generating job bookings in an electronic system, such as the system 105, according to an embodiment of the present invention. The method 200 comprises the step of receiving a project request, such as from an instructor 110, in the electronic system 210. At step 220, the method further comprises assigning a project template to the project request. The project template identifies task work parameters and task time constraints for each of a plurality of tasks required to complete a project. At step 230, the system retrieves supplier work parameters and supplier time constraints concerning first resource suppliers 115 related to the plurality of tasks. At step 240, the system automatically generates first task-supplier matches by matching the supplier work parameters and supplier time constraints with the task work parameters and task time constraints related to the plurality of tasks. At step 250, a comparison of the first task-supplier matches with alternative task-supplier matches concerning alternative resource suppliers is automatically generated. At step 260, the method generates a plurality of project schedule options using the first task supplier matches and the alternative task supplier matches. At step 270, the method generates job bookings based on a project schedule selected from the plurality of project schedule options. The job bookings can be transmitted to an electronic device. For example, the job bookings can be transmitted to a customer and to relevant resource suppliers 115 via one of an email, mobile or web-based application, including associated legal documents to initiate prompt completion of a binding work contract between a project manager and a resource supplier 115.

In some embodiments, the project schedule options can be transmitted to an electronic device of a customer. For example, the project schedule options can be transmitted to a customer via one of an email, mobile or web-based application. The customer can then select one of the plurality of project schedule options and the selection is then transmitted to the electronic system 105. In practice, the project template can be an electronic file that defines task work parameters and task time constraints of an earlier project. The task time constraints can comprise a start and end date relevant to a task. Advantageously, the method 200 allows a resource supplier 115, whether a person or machine, to be chosen based on their previous performance, such as lowest cost, greatest reliability or highest quality, in relation to other resource suppliers 115 and their efficiency in completing a job within specified time constraints, as well as relevant contextual factors such as location and qualifications. Resource suppliers 115 can also be monitored through a geo-tracking application such as on a mobile phone or dedicated tracking device. The geo-tracking application can monitor movement of a resource supplier 115 and proximity to a project site to provide additional data for assessing the efficiency of the resource supplier 115.

In some further embodiments of the present invention, the supplier work parameters can comprise at least one of the first resource supplier's qualifications, experience, location or feedback from previous customers of the first resource supplier.

In use, the electronic system 105 analyses operational data, such as supplier work parameters and customer feedback, in real time so that parameters of the system 105, such as parameters of existing project templates, can be updated, enabling the overall effectiveness of the system 105 to be improved. By analysing contextual data related to a job (e.g. location, time of year, job type, customer demographics), the matching of a first resource supplier 115 to a task can be improved. A first task-supplier match can be generated for a first resource supplier 115 based on the history of work performed on similar jobs. Each of the criteria relating to a first resource supplier can be input from a number of sources, including staff, customers and through self-assessment. By including contextual factors related to tasks on which a first resource supplier was rated, the relevant score becomes a measure of the how well suited the resource supplier is to a given task. Advantageously, using principles of basic machine learning as known in the art, as the electronic system receives and incorporates more data, the electronic system learns and improves the scheduling method.

Embodiments of the present invention are thus advantageously able to automate the process of matching task work parameters and task time constraints with supplier work parameters and supplier time constraints, possibly relating to many tasks, into a convenient set of project schedule options for a customer to select from. From the perspective of a customer, each project schedule option clearly lays out the key data of a task to inform the customer and assist them in choosing an appropriate project schedule option. Further advantageously, a customer can provide feedback on various criteria relating to the performance of a specified resource supplier which can be collated, stored and analysed for the purposes of improving the ability of the electronic system to provide a first task-supplier match on future projects.

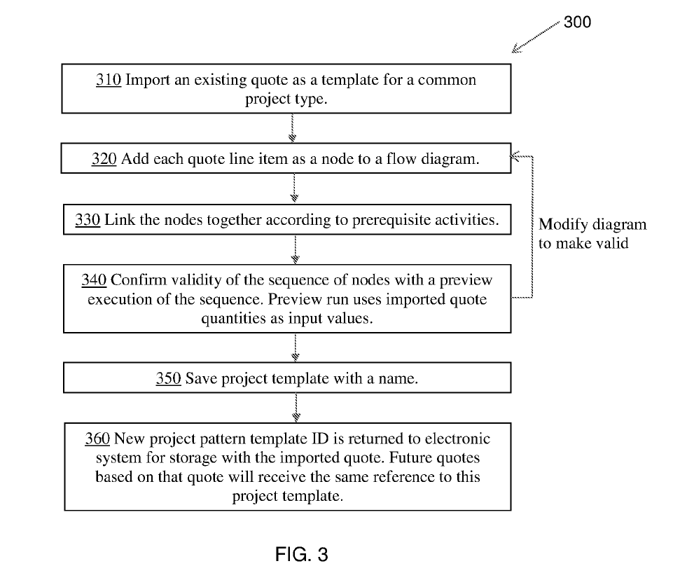

FIG. 3 is a block diagram of a method 300 for assigning a project template as described in step 220 of FIG. 1. The method 300 begins with the step 310 of importing an existing quote as a template for a common project type. For example, common project types can include basic building repairs such as a hole in a wall or rain damage, or large scale jobs such as building a house. At step 320, the method 300 adds each project task as a node to a flow diagram. At step 330, the nodes are linked together to form a chronological sequence such that no tasks can be performed if a relevant prerequisite task has not been completed. At step 340, the electronic system executes the sequence in order to validate the sequence. The method 300 can then loop back to step 320 if a given sequence is determined to be invalid. Otherwise, the method 300 progresses to step 350 which saves the project template under a given ID. At step 360, the given ID for the project template is matched with an imported quote for a given project and saved in the electronic system 105. Thus a project template for future projects requiring tasks similar to a previous quote can be generated using the saved project template.

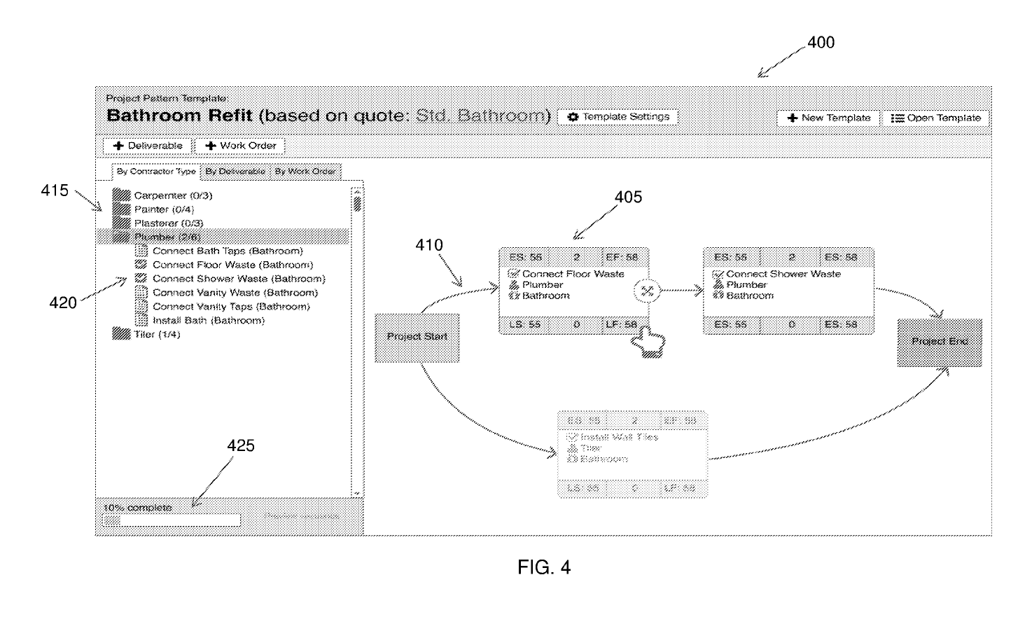

FIG. 4 is an example of a graphical user interface (GUI) 400 for assigning project templates in accordance with the method 300 described in FIG. 3. As described at step 320 of FIG. 3, each task is added as a node 405 to the user interface 400. Each node 405 includes information relevant to the task to be completed and a resource supplier 115. For example, a node 405 can display “Plumber” to indicate a required type of resource supplier 115, “Bathroom” to indicate a region of a building that the task pertains to, and “Connect Floor Waste” to indicate the task to be performed. A node 405 can also include other relevant information such as the expected start and finishing times or days for a particular task. The nodes 405 are linked by lines and arrows 410 to form a chronological sequence in accordance with step 330 of FIG. 3. The interface 400 can include project resource supplier folders 415, which can be named according to an appropriate type of resource supplier 115. For example, the folders 415 can be named “Carpenter”, “Painter” or “Plumber”. When opened, these project resource supplier folders 415 can include specific project tasks 420, such as “Connect Floor Waste (Bathroom)” and “Connect Vanity Taps (Bathroom)”. To ensure all tasks are included in a project template, a progress bar 425 indicates to a user the progress made relating to a particular project template. For example, if a user has added 1 out of 10 tasks to be completed, the progress bar will indicate that 10% of the project template has been completed.

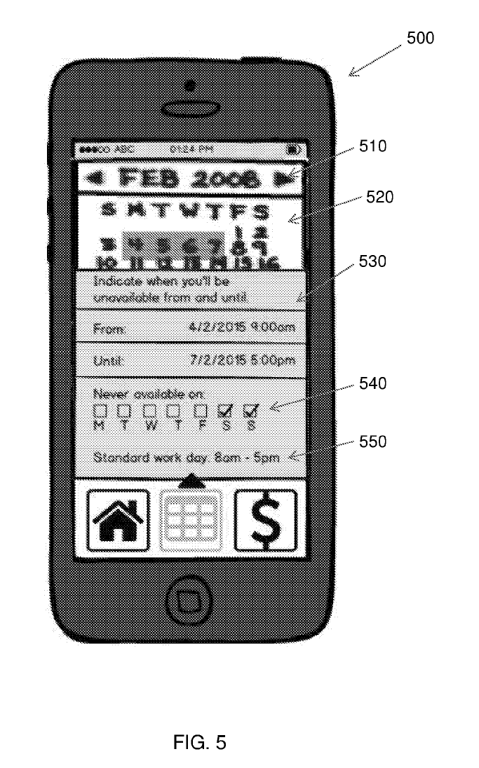

FIG. 5 illustrates a graphical user interface 500 of, for example, a mobile phone, through which a first resource supplier 115 can submit supplier time constraints in accordance with the method described in FIG. 2. Section 510 of the interface 500 allows a resource supplier 115 to select a relevant month and year. Section 520 of the interface 500 displays a calendar type display. A resource supplier 115 can highlight a portion of the calendar to signify particular times that he, she or it will be available or unavailable. Below section 520, section 530 allows a resource supplier 115 to input a date range that they are available or unavailable. For example, as illustrated, a resource supplier can indicate that they are unavailable “From: 4/2/2015 9:00 am” and “Until: 7/2/2015 5:00 pm”. Sections 520 and 530 can be linked such that a change made to one section will be reflected in the other. In section 540, the resource supplier 115 can also nominate times that they are never available. In section 550, the resource supplier 115 can input a “standard work day”, which can detail the typical hours of work of the resource supplier 115. In some embodiments, a first resource supplier 115 can update the supplier work parameters and the supplier time constraints via a mobile application or a web-based application.

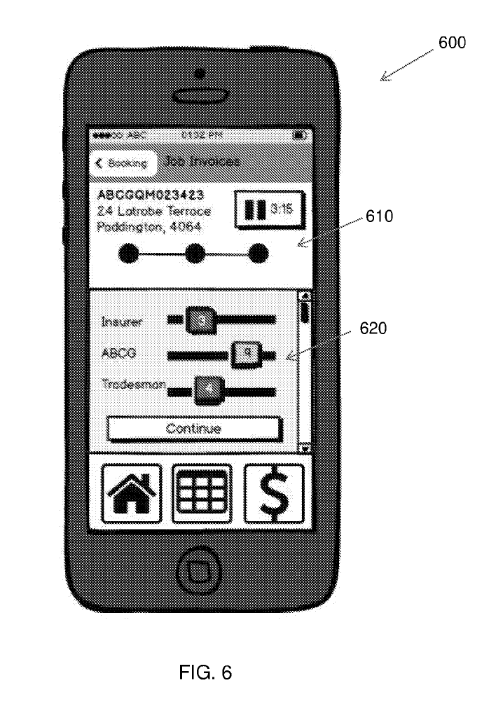

FIG. 6 illustrates a graphical user interface 600 for receiving feedback about a resource supplier 115. For example, the user interface 600 can be sent with an electronic message or invoice to a customer who previously used a specified resource supplier 115. Section 610 of the interface 600 illustrates an invoice of a completed project. As shown, the invoice can include details of the tasks completed during the project, the site where the project was undertaken and the time taken to complete the project. A person skilled in the art will appreciate that the interface 600 can be tailored to display a range of details relevant to a particular task or project. Section 620 illustrates an interactive input mechanism for a customer to input overall scores for parties involved in the project, including instructors 110 and resources suppliers 115. For example, the customer can provide scores for each of the insurer, the system manager and a tradesman who completed a specific task. As shown, when providing feedback, the customer can easily rate each party using a sliding scale mechanism. However, those skilled in the art will appreciate that the feedback can be input in a variety of ways such as an array of numbers or using another suitable input mechanism. A resource supplier 115 can be rated on various performance criteria. For example, a resource supplier 115 can be rated on the quality of their work, their onsite conduct, their punctuality, their ability to complete tasks on schedule and their ability to complete tasks within a budget. A resource supplier 115 also can be rated on other suitable performance factors.

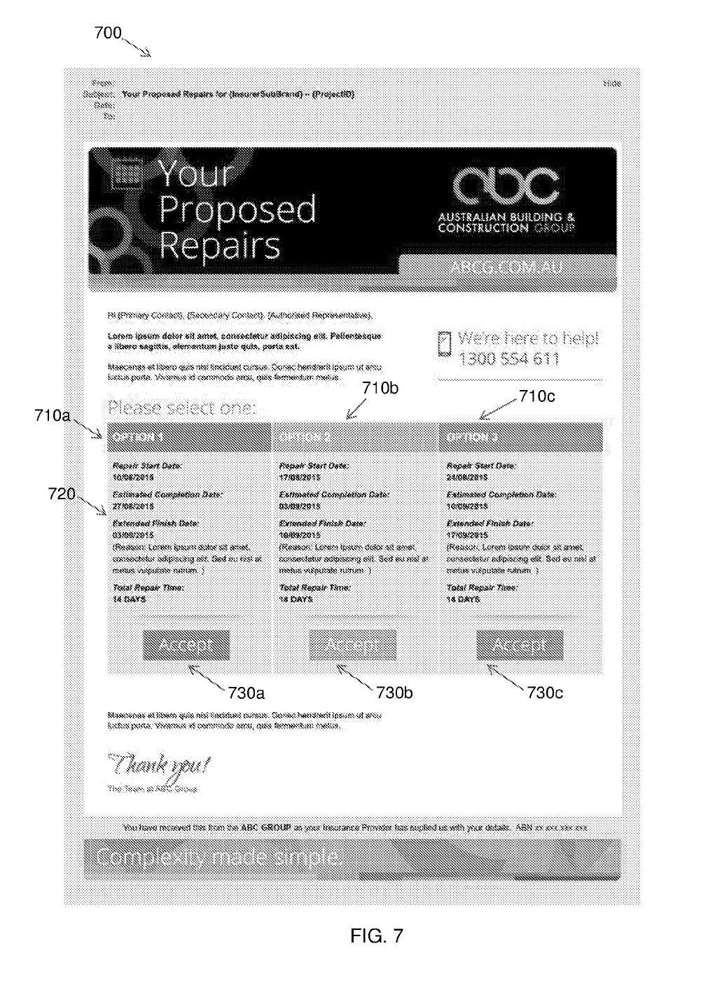

FIG. 7 illustrates a user interface in the form of an output 700 of a plurality of project schedule options 710a, 710b and 710c generated in accordance with method step 260 of FIG. 2. As illustrated, each of the plurality of schedule options 710 can display a range of data in section 720, such as “Repair Start Date”, an “Estimated Completion Date”, an “Extended Finish Date” and a “Total Repair Time”. A customer can review the plurality of schedule options 710a, 710b and 710c and select a preferred schedule option by clicking one of the “Accept” buttons 730a, 730b or 730c relating to the appropriate schedule option. In some alternative embodiments of the present invention, the output 700 can display further details of each option in the plurality of schedule options 710a, 710b and 710c, such as an estimated cost of a specified resource supplier 115.

After a particular project schedule option is selected, job bookings associated with all tasks included in the selected project schedule option can be automatically generated through the system 105. For example, the system 105 can transmit job booking confirmations directly to an electronic calendar associated with a selected resource supplier 115, generate associated contract legal documents, and transmit relevant invoices to the customer or instructor 110 ordering the project.

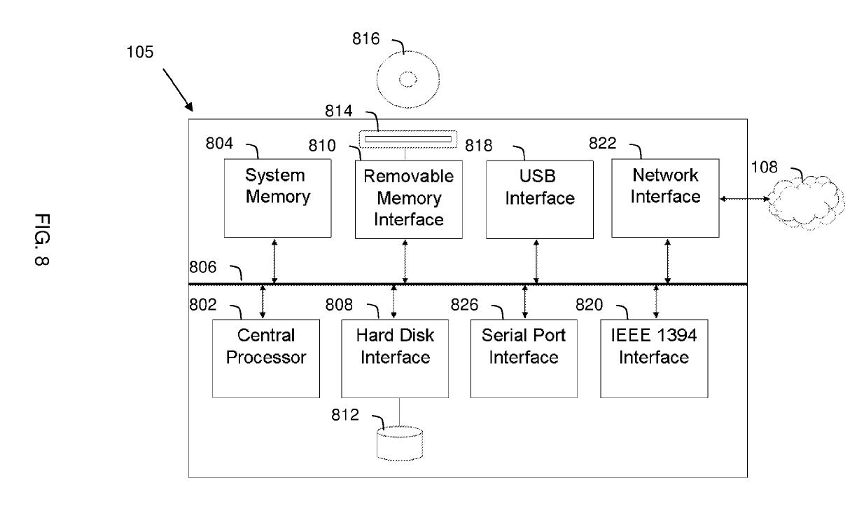

FIG. 8 illustrates a block diagram of a specific embodiment of the electronic system 105, for performing a method according to an embodiment of the present invention.

The electronic system 105 includes a central processor 802, a system memory 804 and a system bus 806 that couples various system components, including coupling the system memory 804 to the central processor 802. The system bus 806 may be any of several types of bus structures including a memory bus or memory controller, a peripheral bus, and a local bus using any of a variety of bus architectures. The structure of system memory 804 is well known to those skilled in the art and may include a basic input/output system (BIOS) stored in a read only memory (ROM) and one or more program modules such as operating systems, application programs and program data stored in random access memory (RAM).

The electronic system 105 can also include a variety of interface units and drives for reading and writing data. In particular, the computing device 800 includes a hard disk interface 808 and a removable memory interface 810, respectively coupling a hard disk drive 812 and a removable memory drive 814 to the system bus 806. Examples of removable memory drives 814 include magnetic disk drives and optical disk drives. The drives and their associated computer-readable media, such as a Digital Versatile Disc (DVD) 816 provide non-volatile storage of computer readable instructions, data structures, program modules and other data for the electronic system 105. A single hard disk drive 812 and a single removable memory drive 814 are shown for illustration purposes only and with the understanding that the computing device 800 can include several similar drives. Furthermore, the computing device 800 can include drives for interfacing with other types of computer readable media.

The electronic system 105 can include additional interfaces for connecting devices to the system bus 806. FIG. 8 shows a universal serial bus (USB) interface 818 which may be used to couple a device to the system bus 806. For example, an IEEE 1394 interface 820 may be used to couple additional devices to the computing device 800.

The electronic system 105 can operate in a networked environment using logical connections to one or more remote computers or other devices, such as a server, a router, a network personal computer, a peer device or other common network node, a wireless telephone or wireless personal digital assistant. The electronic system 105 includes a network interface 822 that couples the system bus 806 to a local area network (LAN) 824. Networking environments are commonplace in offices, enterprise-wide computer networks and home computer systems.

A wide area network (WAN), such as the Internet, can also be accessed by the electronic system 105, for example via a modem unit connected to a serial port interface 826 or via the LAN 824. Transmission of data can be performed using the LAN 824, the WAN, or a combination thereof.

It will be appreciated that the network connections shown and described are exemplary and other ways of establishing a communications link between computers can be used. The existence of any of various well-known protocols, such as TCP/IP, Frame Relay, Ethernet, FTP, HTTP and the like, is presumed, and the computing device 800 can be operated in a client-server configuration to permit a user to retrieve data from, for example, a web-based server.

The operation of the electronic system 105 can be controlled by a variety of different program modules. Examples of program modules are routines, programs, objects, components, and data structures that perform particular tasks or implement particular abstract data types. Some embodiments of the present invention can also be practiced with other computer system configurations, including hand-held devices, multiprocessor systems, microprocessor-based or programmable consumer electronics, network PCs, minicomputers, mainframe computers, personal digital assistants and the like. Furthermore, some embodiments of the present invention can be practiced in distributed computing environments where tasks are performed by remote processing devices that are linked through a communications network. In a distributed computing environment, program modules can be located in both local and remote memory storage devices.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, include one or more physical or logical blocks of computer instructions that may, for instance, be organized as an object, procedure, or function. Nevertheless, the executables of an identified module need not be physically located together, but may include disparate instructions stored in different locations which, when joined logically together, include the module and achieve the stated purpose for the module. Further, modules may be stored on a computer-readable medium, which may be, for instance, a hard disk drive, flash device, RAM, tape, or any other such medium used to store data.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

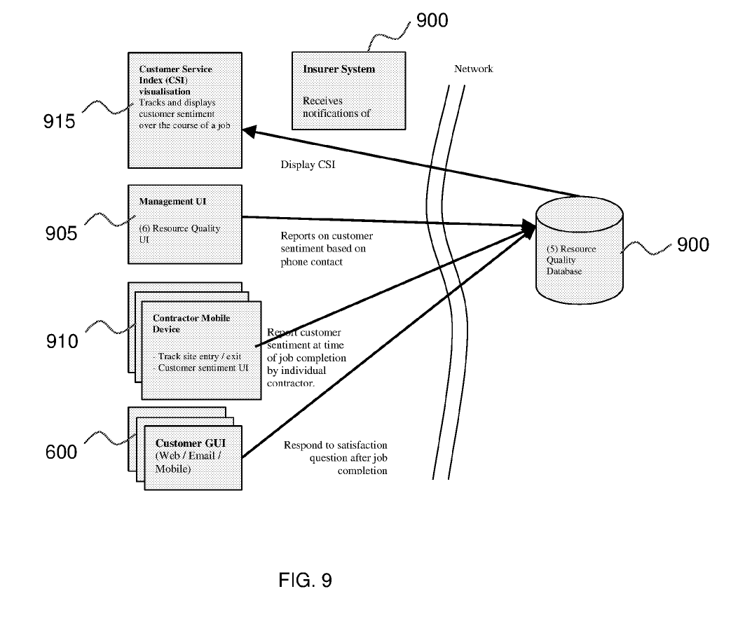

FIG. 9 is a block diagram illustrating the operation of a customer service index (CSI) inside of the network 100, according to an embodiment of the present invention. The CSI enables a customer's sentiment and satisfaction towards each of the various parties involved in a particular project to be monitored throughout the project.

For example, where an insurance company is instructing a building services provider/project manager to contract with various tradesmen to make building repairs, the CSI can monitor in real time the customer's opinion of the performance of the insurer, the project manager, and each of the contracted tradesmen. A resource quality database 900 operatively connected to the electronic system 105 in the network 100 receives updates as follows: A user interface 905 of the project manager transmits data to the database 900 based on direct phone, email or personal contact with a customer 120, including feedback on the performance of any aspect of the project. Also, a mobile device 910 of a contractor transmits data to the database 900 including any feedback provided from the customer directly to the contractor. The device 910 is generally the same device that a contractor uses to run the interface 500 regarding calendaring of the contractor's availability and time constraints. Also, the interface 600 as discussed above is used to report job satisfaction about any of the insurer, the project manager, or a tradesman directly from the customer 120 to the database 900.

Data from the database 900 is then fed to a CSI visualisation interface 915 operating in the electronic system 105 to enable real time tracking of customer sentiment during the course of a project. Reports from the CSI visualisation interface also can be sent directly to an instructor 110, such as an electronic system 920 of the insurer via a business to business (b2b) link.

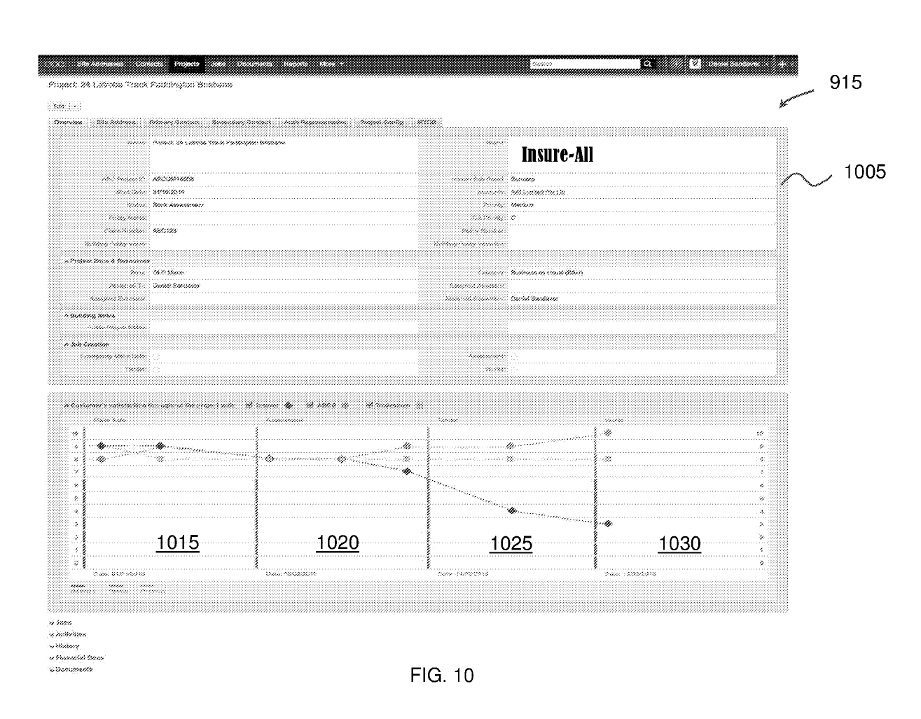

FIG. 10 illustrates an example of the CSI visualisation interface 915, according to some embodiments of the present invention. As shown, general information describing a particular project is displayed in a header 1005. A line graph 1010 then tracks customer satisfaction over the course of the project. For example, the line graph 1010 includes a customer satisfaction rating from 0 to 10 displayed along the Y-axis, and time displayed along the X-axis. The time for the project is then divided into various stages such a “make safe” stage 1015, an assessment stage 1020, a tender stage 1025 and a work stage 1030. Individual lines on the line graph 1010 then track the customer satisfaction over time for each of, for example, the project manager, the insurer and individual tradesmen. If the customer satisfaction concerning any of the parties drops below a predetermined level, such as below 7/10, then an alert can be generated and sent to an appropriate party or to multiple parties to enable quick corrective action to restore the customer's level of satisfaction.

In summary, advantages of embodiments of the present invention include a method and system which can quickly and accurately create job bookings for project tasks with minimal labor or input required from a project manager. Furthermore, the method and system allow a resource supplier to be quickly and efficiently selected based on their previous performance, such as cost, in relation to other resource suppliers and their efficiency in completing a job within given time constraints, as well as relevant contextual factors such as their location and qualifications. Customer satisfaction feedback regarding a project manager, instructor and/or resource supplier then can be provided in real time to various parties to ensure that a level of customer satisfaction does not drop below a predetermined minimum.

It will be readily understood that the components of various embodiments of the present invention, as generally described and illustrated in the figures herein, may be arranged and designed in a wide variety of different configurations. Thus, the detailed description of the embodiments of the present invention, as represented in the attached figures, is not intended to limit the scope of the invention as claimed, but is merely representative of selected embodiments of the invention. Indeed, the above description of various embodiments of the present invention is provided for purposes of description to one of ordinary skill in the related art. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. Accordingly, this patent specification is intended to embrace all alternatives, modifications and variations of the present invention that have been discussed herein, and other embodiments that fall within the spirit and scope of the above described invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1-20. (canceled)

21. A method of generating job bookings in an electronic system, comprising:
receiving a project request in the electronic system;
assigning, by the electronic system, a project template to the project request, wherein the project template identifies task work parameters and task time constraints for each of a plurality of tasks required to complete a project;
retrieving, by the electronic system, supplier work parameters and supplier time constraints concerning first resource suppliers related to the plurality of tasks;
automatically generating first task-supplier matches, by the electronic system, by matching the supplier work parameters and supplier time constraints with the task work parameters and task time constraints related to the plurality of tasks;
automatically generating, by the electronic system, a comparison of the first task-supplier matches with alternative task-supplier matches concerning alternative resource suppliers;
generating, by the electronic system, a plurality of project schedule options using the first task-supplier matches and the alternative task-supplier matches; and
generating job bookings, by the electronic system, based on a project schedule selected from the plurality of project schedule options.

22. The method of claim 21, wherein the project template comprises an electronic file that defines task work parameters and task time constraints of an earlier project.

23. The method of claim 21, wherein the first resource suppliers comprise a contractor, tradesman, inspector, machine, or vehicle.

24. The method of claim 21, wherein the task work parameters and task time constraints identified in the project template are modified to suit current parameters of the project request.

25. The method of claim 21, wherein the task time constraints comprise a start and end date relevant to a task.

26. The method of claim 21, wherein the task work parameters comprise one or more of a task description and a location of the task.

27. The method of claim 21, wherein the supplier work parameters comprise at least one of the first resource suppliers' qualifications, experience, location or feedback from previous customers of the at least one of the first resource suppliers.

28. The method of claim 21, wherein the supplier time constraints comprise one or more times that at least one of the first resource suppliers is available and one or more times that the at least one of the first resource suppliers is not available, as defined in an electronic calendar associated with the at least one of the first resource suppliers.

29. The method of claim 21, wherein the supplier work parameters and supplier time constraints are matched with the task work parameters and task time constraints based on at least one of the qualifications, experience, location, availability or feedback from previous customers of at least one of the first resource suppliers.

30. The method of claim 21, wherein the project request is received via a business-to-business platform.

31. The method of claim 21, wherein the supplier work parameters are retrieved from a mobile application.

32. The method of claim 21, wherein the supplier work parameters are retrieved and updated in the electronic system in real-time.

33. The method of claim 21, wherein the project schedule options are transmitted to an electronic device via one of an email, web application or mobile application.

34. The method of claim 21, wherein the first resource suppliers update the supplier work parameters and the supplier time constraints via a mobile application or a web-based application.

35. The method of claim 21, wherein the supplier work parameters comprise a first resource supplier score that is updated in real time based on feedback from previous customers of the first resource suppliers.

36. The method of claim 21, wherein
the plurality of project schedule options are transmitted to a customer via an email, mobile or web-based application, and
one option from the plurality of project schedule options that is selected by the customer is transmitted to the electronic system.

37. The method of claim 21, wherein the job bookings are transmitted to an email, mobile or web-based application of an electronic device of a customer.

38. The method of claim 21, wherein the method further comprises displaying a customer service index (CSI) on an interface of the electronic system.

39. The method of claim 38, wherein a CSI is generated for each resource supplier and instructor of a project.

40. The method of claim 38, wherein the CSI is based on data received in real time from a plurality of electronic devices associated with a customer and at least one resource supplier.
